(19) United States
(12) Patent Application Publication
(10) Pub. No.: US 2018/0085768 A1
(43) Pub. Date: Mar. 29, 2018

(54) MOBILE SYSTEM AND METHOD FOR AUTOMATICALLY DETECTING APPLICATION QUANTITIES OF A COATING AGENT ON SHEETS OF A CARRIER MATERIAL IN A COATING PROCESS

(71) Applicant: HENKEL AG & CO. KGAA, Dusseldorf (DE)

(72) Inventor: Jens Erban, Kleve (DE)

(21) Appl. No.: 15/788,882

(22) Filed: Oct. 20, 2017

Related U.S. Application Data
(63) Continuation of application No. PCT/EP2016/058927, filed on Apr. 21, 2016.

(30) Foreign Application Priority Data
Apr. 23, 2015 (DE) 10 2015 207 459.5

(51) Int. Cl. B05B 12/00; B05C 11/10

(52) U.S. Cl. CPC B05B 12/004; B05C 11/1005

(57) ABSTRACT

The invention relates to a mobile system (1) for automatically detecting application quantities of a coating agent on sheets (2) of a carrier material in a coating process, comprising: at least one length sensor (10) and at least one width sensor (11, 12) for detecting the length (L) and the width (B) of the sheets (2); a counting sensor (9) for detecting the number of sheets (2); a volumetric meter (13) for determining the amount of the applied coating agent; a data processing unit (20) for further processing the data detected by the length sensor (10), the width sensor (11, 12), the counting sensor (9) and the volumetric meter (13) and to obtain information from this data, and storage medium (22) for storing the detected data and the obtained information. The invention further relates to a method for automatically detecting application quantities of a coating agent on sheets (2) of a carrier material in a coating process by using such a mobile system (1).

### FIELD OF THE INVENTION

The present invention relates to a mobile system for automatically detecting application quantities of a coating agent on sheets of a carrier material in a coating process and a corresponding method using such a mobile system.

### BACKGROUND OF THE INVENTION

In coating processes, a coating agent is applied to a carrier material, wherein for example a paint, a coloring agent or an adhesive can be provided as coating agent. Adhesives are used in particular in lamination processes in which firstly a carrier material is provided with a layer of adhesive before a further material layer is laminated on as a protective or decorative layer. In this way for example packaging materials based on corrugated board are produced by corrugated board sheets initially being provided with an adhesive layer before a printed sheet carrying the desired product information is then laminated on. Laminate panels are also produced in such lamination methods.

Precise knowledge of the application quantity of a coating agent is important both in terms of business management and also processing technology. By application quantity is meant, within the scope of the invention, the quantity of coating agent applied to a given surface area of a carrier material in a specific coating process; in other words, the quantity of coating agent applied per surface unit, for example given in g/m².

As different coating agents can have differences in quality, to achieve the same result a smaller quantity may be required of a higher-quality coating agent A than of a lower-quality coating agent B to coat a given surface area. As differences in quality generally also entail differences in price, the application quantity is an essential value to calculate the actual costs of a coat. This value is needed in order to carry out the coating process as cost-effectively as possible.

The specific application quantity in a coating process also has an impact on further method steps following on from coating or lamination. Generally, a greater application quantity of coating agent also introduces more moisture into the product, which must subsequently be removed by correspondingly adapted drying mechanisms or drying times. The specific knowledge of the application quantity is therefore also important in this connection in order to optimize the coating process here, too.

### SUMMARY OF THE INVENTION

The object of the present invention is to provide a system and a method, by means of which the use of application quantities of a coating agent in a coating process can be detected simply and efficiently.

### BRIEF DESCRIPTION OF THE DRAWINGS

FIG. 1 shows a schematic representation of an embodiment of the mobile system.

### DETAILED DESCRIPTION OF THE INVENTION

This object is achieved by a mobile system according to claim 1 and by a method according to claim 10.

Advantageous embodiments and developments of the invention are the subject of the dependent claims.

According to claim 1, the invention is a mobile system for automatically detecting application quantities of a coating agent on sheets of a carrier material in a coating process, comprising: at least one length sensor and at least one width sensor for detecting the length and the width of the sheets; a counting sensor for detecting the number of sheets; a volumetric meter, such as for example a flowmeter, for determining the quantity of applied coating agent; a data processing unit for further processing the data detected by the length sensor, the width sensor, the counting sensor and the volumetric meter and for obtaining information from this data, and a storage medium for storing the detected data and the obtained information.

In other words, the invention provides a mobile set consisting of different sensors, a connected data processing unit and a storage medium, wherein all parameters required for determining the application quantity of the coating agent can be detected automatically via the sensors and can be supplied to the data processing unit for further processing. The storage medium enables the permanent storage of all data.

The application quantity is determined from the surface area of the sheets to be coated and from the quantity of coating agent applied to the sheets. According to the invention, at least one length sensor and at least one width sensor are provided to automatically determine the surface area of the sheets of the carrier material. The length sensor detects the length of a sheet to be coated, whereas the width sensor detects its width. In a substantially rectangular sheet the length of the sheet is understood to mean its extension in the direction of travel through the coating or laminating system, whereas the width of the sheet describes its extension perpendicular to the direction of travel.

The signals of the length and width sensor are supplied to the data processing unit, which calculates the surface area of a sheet from the automatically detected measurements. The invention also provided a counting sensor for detecting the number of sheets to be coated, the output signal of which is likewise supplied to the data processing unit. The data processing unit calculates the overall surface area to be coated from the surface area of a sheet and the number of sheets to be coated.

To detect the quantity of coating agent applied to the sheets, a volumetric meter is provided according to the invention. Also, the output signal of the volumetric meter is supplied to the data processing unit, and this calculates the application quantity of coating agent per surface area unit, for example in g/m² from the previously determined overall surface area and the quantity of coating agent detected by the volumetric meter.

Both the raw data supplied directly by the sensors and also the information obtained from this raw data using the data processing unit, such as surface area of an individual sheet, overall surface area and application quantity, are stored on a storage medium and are available permanently for later access. The storage medium can for example be a hard drive, external or integrated in the data processing unit, a USB stick, a memory card or the like.

One embodiment of the invention additionally provides a height sensor for detecting the height of the sheets to be coated, wherein also the data detected by the height sensor can be further processed by the data processing unit and can be stored on the storage medium. By the height of the sheets is meant here the height or strength of an individual sheet of the carrier material. The height can be determined via a measurement of a roll gap through which the carrier material is guided. When using corrugated board as carrier material, the type of corrugation of the corrugated board can be detected automatically, in particular via the height sensor.

According to a further proposal, the invention provides two width sensors for detecting the width of a sheet to be coated, wherein a first width sensor is arranged on a first side of the sheet and a second width sensor is arranged on the opposite, second side of the sheet. In this arrangement, the positions of both edges of a sheet are detected in width direction and the data processing unit determines from this and from the known distance between the two width sensors the width of the sheet, by differential formation.

The invention proposes laser sensors as suitable sensors for the length sensor, width sensor and/or height sensor, which laser sensors for example measure distance via a run-time measurement of a laser pulse or via laser triangulation. Such sensors enable contactless measurement.

The counting sensor for detecting the number of sheets can be integrated according to the invention in a generally known sheet feeder. The sheet feeder takes the sheets to be coated individually by means of one or more vacuum exhauster from a stack of sheets and supplies it to the coating system, where it files them according to an adjustable orientation. The counting sensor measures the number of strokes travelled and this measured value is supplied to the data processing unit.

According to a further embodiment of the invention a magnetically inductive flowmeter is proposed as volumetric meter for determining the amount of coating agent applied. Such flowmeters are based on the principle of electromagnetic induction and are suitable for measuring material to be measured which has an electrical minimum conductivity. In a magnetic field applied from outside and oriented perpendicular to the flow direction of the material to be measured, the charge carriers contained in the material to be measured are differently deflected, with the result that a voltage which can be brought about by the separation of charge can be tapped by correspondingly arranged measuring electrodes. This voltage is proportional to the flow rate of the charge carrier. Knowing the cross-section flowed through by the material to be measured and the flow rate, the quantity flowing through can be determined in this way.

Preferably, the system according to the invention has a display device on which the data detected by the sensors and the information obtained therefrom using the data processing unit can be represented. The display device can be a commercially available display which, however, can be designed as a touchscreen, with the result that it is possible to control the data processing system via the touchscreen.

The mobile system according to the invention is suitable, inter alia, for detecting application quantities of adhesive, in particular water-based, foam-free or foamed adhesives. For example, paper- or wood-based materials can be considered as carrier materials for coating, in particular cardboard or corrugated board. The mobile system can e.g. also be used when producing laminate sheets in which a further protective layer or decorative layer is laminated on wood fiber carrier plates.

The mobile system according to the invention is characterized in particular in that all components can be integrated in already existing coating and laminating systems, indeed both for only short-term and also for long-term use. Automatic detection of all data relevant to determining the application quantities is clearly less error-prone than manual determination, input and calculation of this data by an operator, and thus saves working time and costs.

The invention further provides a method for automatically detecting application quantities of a coating agent on sheets of a carrier material in a coating process using a mobile system according to one of claims 1 to 9, comprising the following steps:
determining the length of a sheet using the at least one length sensor;
determining the width of a sheet using the at least one width sensor;
determining the number of sheets using the counting sensor;
determining the quantity of applied coating agent using the volumetric meter;
determining the overall coated surface area from the length, width and number of sheets using the data processing unit;
determining the application quantity of the coating agent from the overall coated surface area and the quantity of applied coating agent using the data processing unit;
storing, on a storage medium, the data detected by the sensors and the counter and the information obtained therefrom using the data processing unit.

As a further step, the method can comprise determining the height of a sheet using a height sensor.

The length and/or the width of a sheet can be determined, according to the invention, via a differential measurement. In so doing, the positions of the edges of a sheet are gauged using the length sensors or width sensors and the length and/or the width of the sheet calculated from the known positions of the sensors relative to the dimensions of the overall system.

The invention is explained in more detail below using an embodiment and with reference to the attached drawing, in which:

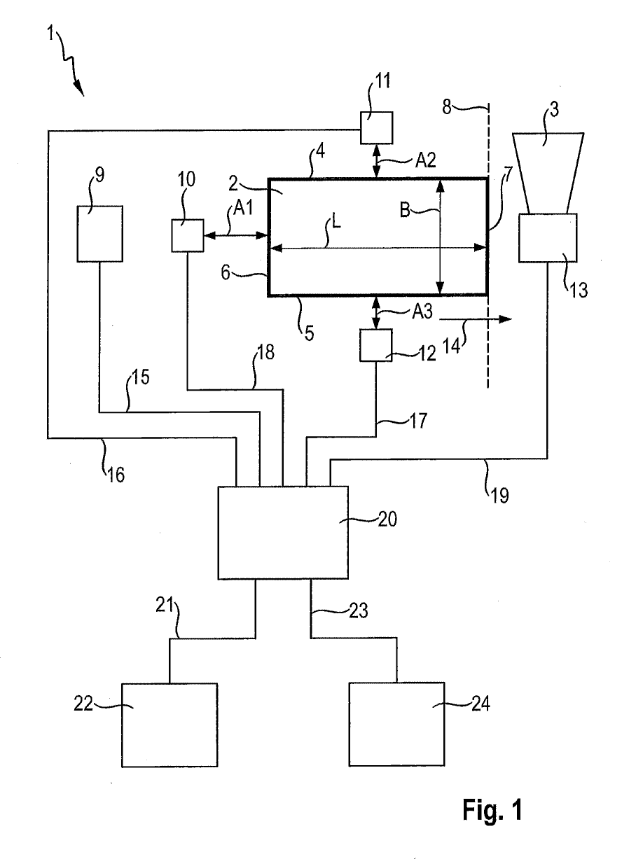

FIG. 1: shows a schematic representation of an embodiment of the mobile system according to the invention.

FIG. 1 shows a mobile system for automatically detecting application quantities of an adhesive on sheets of a cardboard carrier material, the whole system being numbered 1. The individual components of the system are not represented to scale either in terms of their dimensions or in their specific arrangement to one another; instead it is a schematic representation for explaining the general functional principle of the system.

A sheet 2 to be coated, made from cardboard, with a length L and a width B and with edges 4, 5, 6 and 7 lies with its edge 7 against a reference line 8 within an otherwise not shown sheet feeder of a likewise not shown coating system. When the coating system is in operation, the sheet 2 moves through the coating system in the movement direction (“direction of traverse”) displayed by arrow 14.

A length sensor 10 and a first width sensor 11 and a second width sensor 12 are provided to determine the length L and width B of sheet 2 in the region of the sheet feeder. All three sensors 10, 11, 12 are laser sensors which can measure a distance from an object to be measured via a run-time measurement of an emitted laser pulse. The sensors 10, 11, 12 are designed for distance measurements in a range between approximately 50 mm and 2000 mm.

The length sensor 10 is arranged in movement direction behind the sheet 2 and measures the distance between sensor 10 and edge 6 of sheet 2, represented by double-ended arrow A1. The output signal of the length sensor 10 is supplied to a data processing unit 20 via a signal line 18, which data processing unit 20 calculates the length L of sheet 2 from the measurement signal between the sensor 10 and the known distance of the sensor 10 to the reference line 8 of the sheet feeder, by differential formation.

Both width sensors 11 and 12 are arranged opposite one another on a line perpendicular to the movement direction 14. The sensor 11 measures the distance A2 from the edge 4 of sheet 2, whereas the sensor 12 measures the distance A3 from the edge 5 of the sheet. The output signals of the two width sensors 11 and 12 are supplied to the data processing unit 20 via signal lines 16 and 17, which data processing unit 20 calculates the width B of sheet 2 from the measurement signals of the sensors 11 and 12 and from the known distance between the two sensors 11 and 12.

The data processing unit 20 calculates the surface area of the sheet 2 as the product of the determined length L and width B of sheet 2.

To determine the overall surface area to be coated in a coating process, the surface area of an individual sheet 2 is to be multiplied by the number of similar sheets. To determine this number, the mobile system 1 has a counting sensor 9 which is integrated in the sheet feeder. The sheet feeder lifts a sheet 2 from a stack of sheets provided on the coating system using a vacuum suction unit and deposits this on a laminating table of the coating system. The counting sensor 9 detects the strokes of the sheet feeder travelled in the course of a coating process, which correspond to the number of sheets 2 supplied to the coating system, and provides a corresponding output signal to the data processing unit 20 via a signal line 15.

The data processing unit 20 calculates the overall surface area of all sheets 2 as a product of the surface area of an individual sheet 2 and the overall number of processed sheets 2.

If the sheet 2 passes through the coating system in movement direction 14, sheet 2 passes the pasting unit of the coating system, with FIG. 1 showing, schematically, only the supply container 3 for the adhesive. The adhesive is applied to the carrier material in the pasting unit. This happens in per se known manner and is not explained here in more detail. To determine the quantity of the adhesive applied in a coating process, a volumetric meter 13 is connected to the supply container 3. The volumetric meter 13 is a magnetically inductive volumetric meter which determines the throughflow quantity or the throughflow volume from the flow rate of the adhesive and from the cross-section through which flow has taken place. The output signal of the volumetric meter 13 is supplied to the data processing unit 20 via a signal line 19. The volumetric meter 13 is designed for measuring throughflow quantities between approximately 1 L/hour and 1000 L/hour.

The data processing unit 20 calculates the application quantity, for example in g/cm², as the ratio of the adhesive volume and the determined overall surface area of all sheets 2 coated in the coating process using the volumetric meter 13.

All raw data supplied directly by sensors 9, 10, 11, 12 and 13 and information in the data processing unit 20 obtained directly from said data, such as the surface area of an individual sheet 2, the overall surface area of all sheets 2 and the application quantity, are stored permanently on a storage medium 22. In the shown embodiment, the storage medium 22 is a commercially available USB stick which can be connected to the data processing system 20 via a corresponding USB interface 21. The data are stored permanently available on the USB stick 20 for continuous access, with the result that comparisons between different coating processes can be carried out simply. Also, e.g. in the case of complaints, the conditions in a specific coating process can be reviewed retrospectively and the obtained and stored data can thus be used to prevent errors.

Finally, the mobile system 1 has a display 24 which is designed as a touchscreen and is connected to the data processing unit 20 via an interface 23. All the raw data supplied by sensors 9-13 and the information obtained therefrom can be represented on the display 24 and are thus accessible to an operator on the coating system for review, both online during coating, and also at a later time, read out from the storage medium.

The mobile system 1 can contain further sensors in addition to the sensors represented in FIG. 1. Thus, a height sensor for determining the height of the sheet 2 can be provided. If sheet 2 is a sheet made from corrugated board, the type of corrugation of the corrugated board can thus be determined via height measurement. Additionally, sensors can be integrated into the mobile system to detect the moisture or the color of the coated product. The output signals of all sensors can be supplied to data processing unit 20 in the above-described manner, and further processed by same, and stored on storage medium 22 and represented on display 24.

Additionally, further information, such as e.g. the production speed in m/min or sheets/hour, which is of interest to the production sequence, can be obtained from the data supplied by the sensors. Also, the adhesive costs, indicated for example in ∈/m², can be determined directly and thus enable a comparison between different types of adhesive, which takes into account the current use.

### LIST OF REFERENCE NUMERALS

1 Mobile system

2 Sheets

3 Supply container

4 Edge

5 Edge

6 Edge

7 Edge

8 Reference line

9 Counting sensor

10 Length sensor

11 First width sensor

12 Second width sensor

13 Volumetric meter

14 Direction of movement

15 Signal line

16 Signal line

17 Signal line

18 Signal line

19 Signal line

20 Data processing unit

21 Interface

22 Storage medium

23 Interface

24 Display

1. A mobile system (1) for automatically detecting application quantities of a coating agent on sheets (2) of a carrier material in a coating process, comprising:
at least one length sensor (10) and at least one width sensor (11, 12) for detecting the length (L) and the width (B) of the sheets (2);
a counting sensor (9) for detecting the number of sheets (2);
a volumetric meter (13) for determining the amount of the applied coating agent;
a data processing unit (20) for processing the data detected by the length sensor (10), the width sensor (11, 12), the counting sensor (9) and the volumetric meter (13), and
a storage medium (22) for storing the detected data and the obtained information.

2. The mobile system (1) according to claim 1, comprising at least one height sensor for detecting the height of the individual sheets (2), wherein the data detected by the height sensor can be processed by the data processing unit (20) and the data is stored on the storage medium (22).

3. The mobile system (1) according to claim 1, comprising a first and a second width sensor (11, 12) for detecting the width of the sheets (2) of the carrier material, wherein the first width sensor (11) is arranged on a first side and the second width sensor (12) on an opposite, second side of the sheets (2).

4. The mobile system (1) according to claim 2, wherein the at least one length sensor (10), the at least one width sensor (11, 12) and/or the at least one height sensor is a laser sensor.

5. The mobile system (1) according to claim 1, wherein the volumetric meter (13) is a magnetically inductive flowmeter.

6. The mobile system (1) according to claim 1, wherein a display device (24) is provided on which the data detected by the sensors (9, 10, 11, 12, 13) and the information obtained therefrom using the data processing unit (20) can be represented.

7. The mobile system (1) according to claim 1, wherein adhesive is provided as the coating agent.

8. The mobile system (1) according to claim 1, wherein the carrier material is a paper or wood.

9. The mobile system (1) according to claim 1, wherein the carrier material is a corrugated board.

10. A method for automatically detecting application quantities of a coating agent on sheets (2) of a carrier material in a coating process using a mobile system (1) according to claim 1, comprising the steps:
determining the length (L) of a sheet (2) using the at least one length sensor (10); p1 determining the width (B) of a sheet (2) using the at least one width sensor (11, 12);
determining the number of sheets (2) using the counting sensor (9);
determining the quantity of applied coating agent using the volumetric meter (13);
determining the overall coated surface area from the length (L), width (B) and number of sheets (2) using the data processing unit (20);
determining the application quantity of the coating agent from the overall coated surface area and the quantity of applied coating agent using the data processing unit (20);
storing, on a storage medium (22), the data detected by the counting sensor (9), length sensor (10), at least one width sensor (11, 12), and the volumetric meter (13) and the information obtained therefrom using the data processing unit (20).

11. The method according to claim 10, additionally comprising the step of determining the height of a sheet (2).

12. The method according to claim 10, wherein the length (L) and/or the width (B) of the sheets (2) is determined via a differential measurement.
